(19) United States
(12) Patent Application Publication
(10) Pub. No.: US 2026/0164118 A1
(43) Pub. Date: Jun. 11, 2026

(54) IMAGE PROCESSING APPARATUS, CONTROL METHOD FOR IMAGE PROCESSING APPARATUS, IMAGE PICKUP APPARATUS, AND STORAGE MEDIUM

(71) Applicant: CANON KABUSHIKI KAISHA, Tokyo (JP)

(72) Inventor: YOICHI TAKAHASHI, Tokyo (JP)

(21) Appl. No.: 19/385,434

(22) Filed: Nov. 11, 2025

(30) Foreign Application Priority Data
Dec. 9, 2024 (JP) 2024-214496

(51) Int. Cl. H04N 23/60; G06T 5/50; G06T 5/73

(52) U.S. Cl. CPC H04N 23/64; G06T 5/50; G06T 5/73; G06T 2207/20221

(57) ABSTRACT

An image processing apparatus capable of reducing tone jump in a composite image obtained by compositing a plurality of images is provided. The image processing apparatus includes at least one processor or circuit and a memory storing instructions to cause the at least one processor or circuit to perform operations of the following units: an obtaining unit that obtains RAW data of a plurality of still images, a compositing unit that generates a composite image of the plurality of still images by compositing the RAW data, an adding unit that adds noise to the composite image, and a determining unit that determines a noise amount to be added to the composite image based on photographing conditions of the plurality of still images or information extracted from the composite image.

### BACKGROUND

### Field of the Technology

The present disclosure relates to an image processing apparatus, a control method for the image processing apparatus, an image pickup apparatus, and a storage medium, and in particular to an image composition technique.

### Description of the Related Art

When photographing a high-brightness subject with an image pickup apparatus such as a digital camera, a method for achieving a proper exposure by suppressing the occurrence of blown-out highlights, by reducing the amount of light incident on an image pickup device (an image sensor) using a neutral density filter (an ND filter) has been widely used.

However, there is an issue in that the operation of attaching and detaching an ND filter is troublesome. In addition, in the case where an ND filter has been built into an image pickup apparatus, the ND filter is capable of being easily inserted into and retracted from the incident light path, but this results in the image pickup apparatus becoming larger, heavier, and more expensive.

In order to deal with such an issue, a technique has been disclosed that suppresses blown-out highlights in the same way as in the case where photographing has been performed by using a physical ND filter, by compositing a plurality of images, which have been captured with divided exposures, without attaching a physical ND filter (for example, see Japanese Laid-Open Patent Publication (kokai) No. 2015-136087).

When performing addition-averaging composition with respect to the plurality of images, which have been captured with the divided exposures, as with the technique that has been disclosed in Japanese Laid-Open Patent Publication (kokai) No. 2015-136087, tone jump may become noticeable due to the reduced noise in the composite image.

### SUMMARY

The present disclosure provides an image processing apparatus, a control method for the image processing apparatus, an image pickup apparatus, and a storage medium that are capable of reducing tone jump in a composite image obtained by compositing a plurality of images.

Accordingly, a first aspect of the present disclosure provides an image processing apparatus comprising at least one processor or circuit and a memory storing instructions to cause the at least one processor or circuit to perform operations of the following units: an obtaining unit that obtains RAW data of a plurality of still images, a compositing unit that generates a composite image of the plurality of still images by compositing the RAW data, an adding unit that adds noise to the composite image, and a determining unit that determines a noise amount to be added to the composite image based on photographing conditions of the plurality of still images or information extracted from the composite image.

Accordingly, a second aspect of the present disclosure provides an image pickup apparatus comprising an image sensor, and at least one processor or circuit and a memory storing instructions to cause the at least one processor or circuit to perform operations of the following units: a compositing unit that generates a composite image of a plurality of still images, which have been photographed by the image sensor, by compositing RAW data of the plurality of still images, an adding unit that adds noise to the composite image, and a determining unit that determines a noise amount to be added to the composite image based on photographing conditions of the plurality of still images or information extracted from the composite image.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that illustrates a schematic configuration of an image pickup apparatus according to an embodiment of the present disclosure.

FIG. 2 is a flowchart for explaining the operations of the image pickup apparatus shown in FIG. 1 in an ND composition mode.

FIG. 3 is an example of a definition table of a noise amount to be applied to a composite image.

### DESCRIPTION OF THE EMBODIMENTS

The present disclosure will now be described in detail below with reference to the accompanying drawings showing embodiments thereof.

Hereinafter, an embodiment of the present disclosure will be described in detail with reference to the accompanying drawings. Here, an image pickup apparatus that includes the functions serving as an image processing apparatus according to the present disclosure will be taken up.

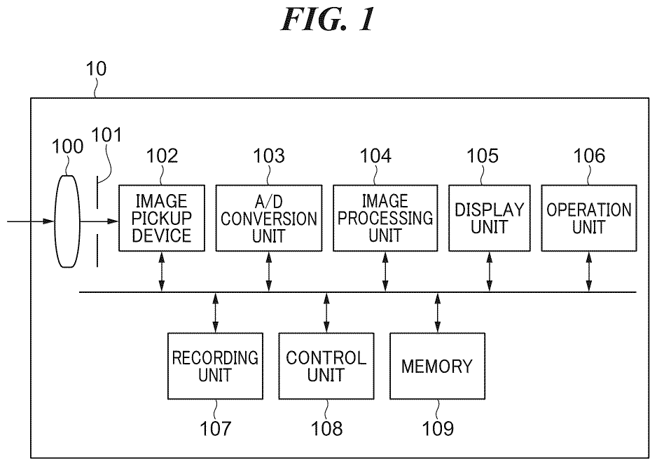

FIG. 1 is a block diagram that illustrates a schematic configuration of an image pickup apparatus 10 according to the embodiment of the present disclosure. As shown in FIG. 1, the image pickup apparatus 10 includes a lens 100, a mechanical shutter 101, an image pickup device (an image sensor) 102, an A/D conversion unit 103, an image processing unit 104, a display unit 105, an operation unit 106, a recording unit 107, a control unit 108, and a memory 109.

The control unit 108 is a microcomputer configured to include a processor (a central processing unit (CPU)) that executes programs, a random-access memory (RAM), a read-only memory (ROM), etc. The aspect of the control unit 108 may be, for example, a system-on-a-chip (SoC), or a system-in-a-package (SiP).

The control unit 108 comprehensively controls the operations of the respective units (the respective components) of the image pickup apparatus 10 and also controls the operations of external device(s) (not shown) connected to the image pickup apparatus 10, by the CPU loading programs, which have been stored in the ROM, into the RAM, and executing them. In other words, the control unit 108 is capable of performing respective functions of the image pickup apparatus 10 by executing predetermined programs. It should be noted that the functions that are capable of being realized by the control unit 108 executing the programs may be implemented by hardware such as application-specific integrated circuits (ASICs) or field programmable gate arrays (FPGAs). The ROM included in the control unit 108 is electrically rewritable, and has stored setting values and graphical user interface data (GUI data) of the image pickup apparatus 10 in addition to the programs to be executed by the CPU.

Although only one lens is shown in FIG. 1 as the lens 100, practically, the lens 100 is configured to include a plurality of lenses, and forms an optical image of a subject on an image pickup surface of the image pickup device 102. It should be noted that in the present embodiment, the lens 100 includes a diaphragm (not shown). The image pickup device (the image sensor) 102 is, for example, a complementary metal oxide semiconductor (CMOS) sensor, and generates analog electrical signals, each of which serves as a pixel signal having a value corresponding to the amount of charge generated during a charge accumulation period, from the optical image that has been formed on the image pickup surface. It should be noted that the image pickup device 102 has a light-shielding area.

The mechanical shutter 101 controls an exposure time (a charge accumulation time) for the image pickup device 102 by performing opening and closing operations during still image photographing, and is maintained in an open state during moving image photographing. It should be noted that in the case where the image pickup device 102 includes a global shutter mechanism, the mechanical shutter 101 does not need to be used.

When one charge accumulation period ends in the image pickup device 102, pixel signals (analog pixel signals) for one frame (one still image) are read out from the image pickup device 102, and the analog pixel signals, which have been read out, are input into the A/D conversion unit 103. The A/D conversion unit 103 A/D-converts the analog pixel signals to generate digital pixel signals, and transmits the digital pixel signals to the memory 109 and the image processing unit 104. It should be noted that in the case where the image pickup device 102 is configured to be able to output digital pixel signals, the A/D conversion unit 103 is not necessary.

The digital pixel signal outputted from the A/D conversion unit 103 has only one color component corresponding to the color (usually, one color of red (R), green (G), and blue (B)) of a filter (a unit filter) that has been provided in the corresponding pixel. In the description of the present embodiment, image signals in digital format (digital-format image signals), which are made up of the digital pixel signals, each of which has only one color component corresponding to the color of the unit filter, will be referred to as “RAW data”.

The RAW data outputted from the A/D conversion unit 103 is temporarily stored in the memory 109. In addition to the RAW data, the memory 109 temporarily stores image data generated by the image processing unit 104 performing a predetermined development processing with respect to the RAW data, etc.

The image processing unit 104 performs the development processing with respect to the RAW data that has been obtained from the A/D conversion unit 103 to generate image data. The development processing is a general term for a plurality of image processing, such as a color interpolation processing and a tone correction processing (gamma processing). It should be noted that the color interpolation processing is a processing for interpolating values of color components that are not capable of being obtained during photographing, and is also referred to as “demosaic processing”. By applying the color interpolation processing, the digital signal for each of the pixels that constitute the image data comes to have a plurality of color components (for example, RGB or YCbCr) that are necessary for a color image.

In addition, with respect to the image data, the image processing unit 104 performs a detection processing of feature regions such as face regions and human body regions and a detection processing of their movements, a person recognition processing, a detection processing of various kinds of objects, an image composition processing, a scaling processing, an encoding/decoding processing, etc. Furthermore, the image processing unit 104 performs a data processing such as a header information generation processing, and various kinds of image processing such as a generation processing of signals and evaluation values that are to be used for autofocus detection (AF) and a calculation processing of evaluation values that are to be used for automatic exposure control (AE). It should be noted that the image processing that are capable of being performed by the image processing unit 104 are not limited to these processing that have been described above.

The display unit 105 is, for example, a touch panel type display, and displays live view images, playback images, a graphical user interface (a GUI), the setting values and information of the image pickup apparatus 10, etc. The operation unit 106 is configured to include various kinds of input devices (such as switches, keys, buttons, a dial, a touch panel, etc.) that allow a user to give (issue) various kinds of instructions to the image pickup apparatus 10 (the control unit 108). In addition, the display unit 105 is configured to include a touch panel, and therefore functions as one of the various kinds of input devices that are included in the operation unit 106. The recording unit 107 is a recording medium such as a memory card that records the RAW data, the image data, composite RAW data, information and audio data that are associated with these pieces of data, etc., in accordance with recording conditions that have been set, and a photographing mode. It should be noted that the composite RAW data is generated by the image processing unit 104 compositing a plurality of pieces of RAW data.

With the image pickup apparatus 10 that has been configured as described above, it becomes possible to set and execute a light reduction composition mode (an ND composition mode). In the ND composition mode, the density of light reduction (the density of ND) is set, divided exposure is performed in accordance with the density of ND (hereinafter, referred to as “ND density”), and addition-averaging composition is performed. By using the ND composition mode, even in slow shutter photographing to be performed without attaching an ND filter, it is possible to perform photographing that suppresses the occurrence of blown-out highlights in the same way as in the case where an ND filter has been attached.

Before describing the operations of the image pickup apparatus 10 in the ND composition mode, an addition processing, an addition-averaging processing, a noise component generation processing, and a noise component addition processing, which are particularly important in the image composition processing to be executed in the ND composition mode, will be described.

The image composition processing is a processing that composites a plurality of still images to generate a composite image. Each of the plurality of still images is configured with a large number of pixels that have been arranged two-dimensionally, and the coordinates of the pixels are expressed as ‘[x, y]’ by using an xy orthogonal coordinate system. It should be noted that the coordinates of the pixels of the composite image are also expressed as ‘[x, y]’. The number of the still images to be composited is set to ‘N (N: an integer of 2 or more)’, the luminance value of a pixel at the coordinates [x, y] in the still image is represented as ‘I_i[x, y](i=1 to N)’, and the luminance value of a pixel at the coordinates [x, y] in the composite image is represented as ‘I[x, y]’.

The image processing unit 104 calculates the luminance value I[x, y] of each pixel of the composite image in accordance with a composition processing method to be used.

In the case of using the composition processing method based on the addition processing, the image processing unit 104 generates a composite image by the addition processing, based on the following Expression 1. In the addition processing, the luminance value of each pixel of the composite image is obtained by adding the luminance values of the pixels at the same coordinates in the respective still images. The addition processing is used, for example, in the case of generating an image with a proper exposure by compositing N images that have been captured with an exposure amount that is 1/N of a proper exposure amount.

On the other hand, in the case of using the composition processing method based on the addition-averaging processing, the image processing unit 104 generates a composite image by the addition-averaging processing, based on the following Expression 2. In the addition-averaging processing, the luminance value of each pixel of the composite image is obtained by performing gain reduction that divides a luminance value, which is obtained by adding the luminance values of the pixels at the same coordinates in the respective still images, by the number of the still images. The addition-averaging processing is used, for example, in the case of compositing a plurality of images with the same exposure to obtain an image with a pseudo-longer shutter speed without causing blown-out highlights. In the addition-averaging processing, the amount of the gain reduction is changed for each of various kinds of feature regions and object regions that have been detected by the image processing unit 104, thereby making it possible to adjust the luminance for each region within the image.

$$I [ x , y ] = {\sum }_{i = 1}^{N} I\_i [ x , y ] \qquad [ Expression 1 ]$$

$$I [ x , y ] = {\sum }_{i = 1}^{N} I\_i [ x , y ] / N \qquad [ Expression 2 ]$$

The image processing unit 104 is capable of performing the noise component generation processing and the noise component addition processing, when performing image composition. The noise component to be generated here is, for example, Gaussian noise with a mean value of 0 (zero) and a standard deviation σ, but is not limited to the Gaussian noise with the mean value of 0 (zero) and the standard deviation σ, and may be uniformly distributed noise. The noise amount of the Gaussian noise is capable of being changed by changing the standard deviation σ to an arbitrary value. By adding the noise component, which has been generated for each pixel of an input image, to the input image, an image, to which noise has been added, is obtained.

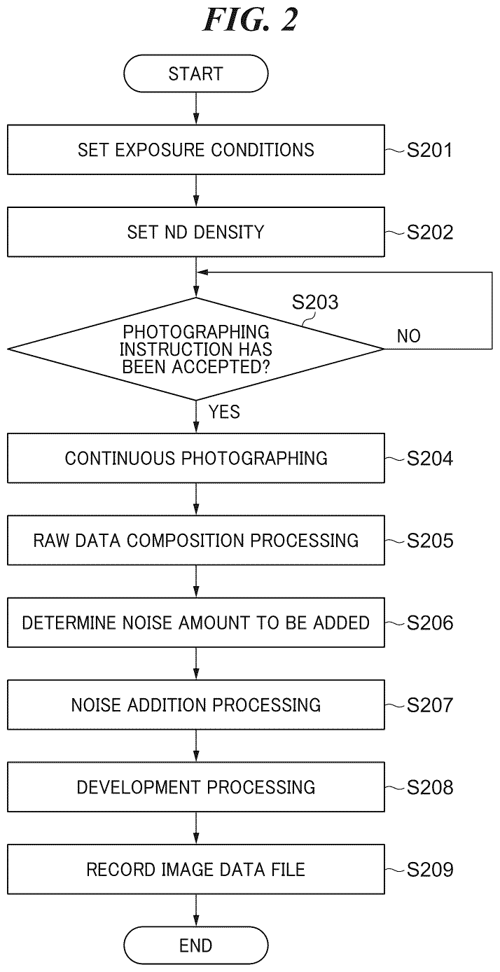

Next, the operations of the image pickup apparatus 10 in the light reduction composition mode (the ND composition mode) will be described. FIG. 2 is a flowchart for explaining the operations of the image pickup apparatus 10 in the light reduction composition mode (the ND composition mode). Respective processes (respective steps) indicated by S numbers in the flowchart of FIG. 2 are realized by the control unit 108 executing a predetermined program to comprehensively control the operations of the respective units (the respective components) of the image pickup apparatus 10.

As shown in FIG. 2, in S201, the control unit 108 accepts setting of exposure conditions from the user via the operation unit 106, and sets an ISO sensitivity, an aperture value, and a shutter speed.

In 202, the control unit 108 accepts setting for the ND density from the user via the operation unit 106, and sets the ND density. For example, the ND density that is settable is ND2, ND4, ND8, ND16, or ND32, but the ND density may be capable of being set to a higher density.

In S203, the control unit 108 determines whether or not a photographing instruction has been accepted from the user via the operation unit 106. The photographing instruction is, for example, a full-pressing operation of a shutter button (not shown) that is included in the operation unit 106. In the case where the control unit 108 determines that a photographing instruction has not been accepted (NO in S203), the control unit 108 repeats the determination process of S203, and on the other hand, in the case where the control unit 108 determines that a photographing instruction has been accepted (YES in S203), the control unit 108 executes the process of S204.

In S204, the control unit 108 executes continuous photographing (performs a continuous photographing processing). Exposure conditions and the number of images to be photographed (the number of images to be captured) in the continuous photographing are determined by the exposure conditions that have been set in S201, and the ND density that has been set in S202. Specifically, a shutter speed of the continuous photographing is determined by setting the value of the ND density to the number of images to be photographed, and evenly dividing the shutter speed that has been set in S201 by the number of images to be photographed. As an example, in the case where the user has set the ND density to ND2 and the shutter speed to four seconds, the continuous photographing is executed under the conditions that the number of images to be photographed is two and the shutter speed is two seconds. The control unit 108 saves (stores), in the memory 109, RAW data that has been obtained by the continuous photographing processing performed in S204.

In S205, the control unit 108 causes the image processing unit 104 to execute a composition processing that generates a composite image (composite RAW data) by compositing all of the continuous-photographed images (by compositing the RAW data that has been obtained by the continuous photographing processing performed in S204). At this time, the image processing unit 104 executes the composition processing by the addition-averaging processing.

In S206, the control unit 108 determines an amount of noise to be added to the composite image (a noise amount to be added to the composite image). The amount of noise to be added (the noise amount to be added) is determined by changing the standard deviation σ of the Gaussian noise, in accordance with the ISO sensitivity that has been set in S201, and the number of the images that have been used in the image composition performed in S205 (that is, the value of the ND density that has been set).

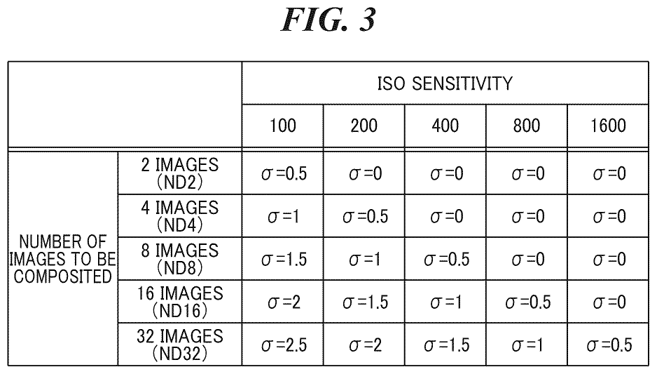

FIG. 3 is an example of a definition table of the noise amount to be set in accordance with the ISO sensitivity, and the number of images to be composited (the number of the continuous-photographed images that have been used to generate the composite image). As shown in the definition table of FIG. 3, the lower the ISO sensitivity and the greater the number of images to be composited, the larger the standard deviation σ is set to, and the greater the noise amount to be added. In addition, the higher the ISO sensitivity and the fewer the number of images to be composited, the smaller value the standard deviation σ is set to, and the smaller the noise amount to be added. In the case where the standard deviation σ is zero (the standard deviation σ=0), no noise is added.

It should be noted that in the present embodiment, the noise amount to be added to the composite image has been determined in accordance with the combination of the ISO sensitivity and the number of images to be composited, but the noise amount to be added to the composite image may be determined based on either the ISO sensitivity or the number of images to be composited alone. In addition, since there are more regions where tone jump is noticeable in the case where there is little texture in an image, the amount of texture in the image may be detected, and in the case where the amount of texture is large, the noise amount to be added to the composite image may be set to zero (that is, the standard deviation σ=0). In this case, for example, edge extraction is performed with respect to the composite image to generate an edge image, region division is performed with respect to the edge image (the edge image is divided into regions), an integral value of an edge amount for each divided region is obtained, and the region where the integral value of the edge amount is equal to or greater than a predetermined threshold value is determined to have a lot of texture. Here, a general edge extraction filter such as a Sobel filter is capable of being used for the edge extraction. A ratio of the regions where the integral value of the edge amount is equal to or greater than the predetermined threshold value to the total number of the divided regions is calculated, and in the case where the obtained ratio is greater than a preset value, the noise amount to be added to the composite image is set to zero (that is, no noise is added).

In S207, the control unit 108 adds the noise amount that has been determined in S206 to the composite image that has been generated by the image processing unit 104 in S205.

In S208, the control unit 108 causes the image processing unit 104 to develop the composite image, to which noise has been added in S207, and generate an image data file storing the development-processed image data (the developed image data).

In S209, the control unit 108 transmits the image data file, which has been generated by the image processing unit 104, to the recording unit 107, records (stores) the image data file in the recording unit 107, and then ends the processing of FIG. 2. This causes the image pickup apparatus 10 to transition to a photographing standby state. It should be noted that in S209, the composite RAW data may be recorded in addition to the development-processed image data, or instead of the development-processed image data.

According to the present embodiment, when generating a composite image by compositing a plurality of images by the addition-averaging processing, the noise amount to be added to the composite image is determined based on photographing conditions and composition conditions, such as the ISO sensitivity and/or the number of images to be composited. As a result, it becomes possible to effectively suppress the occurrence of the tone jump in the composite image.

Next, another example of the method for determining the noise amount to be added to the composite image will be described. In the above embodiment, a method has been adopted in which the noise amount to be added to the composite image is determined based on the ISO sensitivity and/or the number of images to be composited. However, instead of this method, a method may be adopted in which a standard deviation λ of signal values in the light-shielding area of the composite RAW data is detected, and the noise amount to be added to the composite image is determined based on the standard deviation λ.

In this case, a threshold value τ for determining whether or not noise addition is necessary in comparison with the standard deviation λ is set in advance and is stored (in the ROM or the like included) in the control unit 108. Then, a difference amount δ between the standard deviation λ in the light-shielding area of the composite image, and the threshold value τ is detected, and in the case where the standard deviation λ is smaller than the threshold value τ, the standard deviation σ of the noise to be added is changed in accordance with the difference amount δ. At this time, the larger the difference amount δ, the larger the standard deviation σ of the noise to be added, thereby increasing the noise amount to be added. On the other hand, in the case where the standard deviation λ is equal to or greater than the threshold value τ, the standard deviation σ of the noise to be added is set to zero so that no noise is added. Even with such a method, it becomes possible to effectively suppress the occurrence of the tone jump in the composite image.

Next, another example of the method for generating a composite RAW image (the composite RAW data) will be described. In the above embodiment, a method has been adopted in which the composite RAW image (the composite RAW data) is generated by using the addition-averaging processing. However, instead of this method, a method may be adopted in which the addition processing and the addition-averaging processing are switched to be applied depending on regions in the image, thereby achieving the effect of suppressing blown-out highlights depending on the regions in the image.

In this case, the user selects, by using a boundary line, a region where he/she wants to suppress blown-out highlights, thereby separating a region where blown-out highlights are to be suppressed from region(s) where blown-out highlights are not to be suppressed. Since the tone jump becomes more noticeable due to the reduction of the noise amount in the case where the addition-averaging processing has been used, the addition-averaging processing is performed with respect to the region where the user wants to suppress blown-out highlights, and furthermore, a predetermined amount of noise is added to the region where the user wants to suppress blown-out highlights. On the other hand, with respect to region(s) other than the region where the user wants to suppress blown-out highlights, the addition processing is performed, and furthermore, the addition of noise is not performed. As a result, it is possible to reduce the tone jump in the region where the user wants to suppress blown-out highlights without adding noise to the region(s) other than the region where the user wants to suppress blown-out highlights.

The present disclosure has been described above in detail based on its embodiments, but the present disclosure is not limited to these specific embodiments, and various forms within the scope of the gist of the disclosure are also included in the present disclosure. Furthermore, each of the above-described embodiments merely represents one embodiment of the present disclosure, and each embodiment can be combined as appropriate.

For example, in the above embodiment, the present disclosure has been described by being embodied as a digital camera. However, the present disclosure does not necessarily have to be embodied as an apparatus with an image pickup function, but is capable of being applied to various kinds of electronic devices equipped with an image processing means capable of performing a composition processing of a plurality of images that are configured with digital data. For example, the present disclosure is also applicable to various kinds of computers such as personal computers and tablet computers, and electronic devices such as smartphones.

According to the present disclosure, it is possible to reduce the tone jump in a composite image obtained by compositing a plurality of images.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-214496, filed Dec. 9, 2024, which is hereby incorporated by reference herein in its entirety.

What is claimed is:

1. An image processing apparatus comprising:
at least one processor or circuit and a memory storing instructions to cause the at least one processor or circuit to perform operations of the following units:
an obtaining unit that obtains RAW data of a plurality of still images;
a compositing unit that generates a composite image of the plurality of still images by compositing the RAW data;
an adding unit that adds noise to the composite image; and
a determining unit that determines a noise amount to be added to the composite image based on photographing conditions of the plurality of still images or information extracted from the composite image.

2. The image processing apparatus according to claim 1, wherein
one of the photographing conditions is a value of ISO sensitivity, and
the determining unit determines the noise amount so that the smaller the value of the ISO sensitivity, the larger the noise amount.

3. The image processing apparatus according to claim 1, wherein
the plurality of still images are captured by continuous photographing, and
the determining unit determines the noise amount so that the greater the number of the plurality of still images, the larger the noise amount.

4. The image processing apparatus according to claim 1, wherein
the at least one processor or circuit is caused to further perform operations of the following units:
a generating unit that generates an edge image by edge extraction performed with respect to the composite image; and
a dividing unit that divides the edge image into regions, and
the determining unit determines the noise amount based on an edge amount for each region divided by the dividing unit.

5. The image processing apparatus according to claim 1, wherein
the at least one processor or circuit is caused to further perform operations of the following units:
a calculating unit that calculates a standard deviation of signal values in a light-shielding area of the composite image; and
a storing unit that stores a threshold value for determining whether or not noise needs to be added to the composite image with respect to a value of the standard deviation, and
the determining unit increases the noise amount as a difference amount between the standard deviation and the threshold value increases in a case where the standard deviation is smaller than the threshold value, and sets the noise amount to zero in a case where the standard deviation is equal to or larger than the threshold value.

6. The image processing apparatus according to claim 1, wherein
the compositing unit composites the plurality of still images by addition-averaging.

7. The image processing apparatus according to claim 1, wherein
the at least one processor or circuit is caused to further perform operations of a selecting unit that accepts a user's selection of a region where blown-out highlights are to be suppressed,
the compositing unit applies an addition-averaging processing with respect to the selected region and applies an addition processing with respect to other regions, and
the adding unit adds a noise amount to the region, to which the addition-averaging processing has been applied, and does not add noise to the other regions, to which the addition processing has been applied.

8. The image processing apparatus according to claim 1, wherein
the noise to be added to the composite image is Gaussian noise with a predetermined standard deviation.

9. An image pickup apparatus comprising:
an image sensor; and
at least one processor or circuit and a memory storing instructions to cause the at least one processor or circuit to perform operations of the following units:
a compositing unit that generates a composite image of a plurality of still images, which have been photographed by the image sensor, by compositing RAW data of the plurality of still images;
an adding unit that adds noise to the composite image; and
a determining unit that determines a noise amount to be added to the composite image based on photographing conditions of the plurality of still images or information extracted from the composite image.

10. A control method for an image processing apparatus, the control method comprising:
a step of obtaining RAW data of a plurality of still images;
a step of generating a composite image of the plurality of still images by compositing the RAW data of the plurality of still images;
a step of determining a noise amount to be added to the composite image based on photographing conditions of the plurality of still images or information extracted from the composite image; and
a step of adding noise of the noise amount to the composite image.

11. A non-transitory computer-readable storage medium storing a program for causing a computer to execute a control method for an image processing apparatus, the control method comprising:
a step of obtaining RAW data of a plurality of still images;
a step of generating a composite image of the plurality of still images by compositing the RAW data of the plurality of still images;
a step of determining a noise amount to be added to the composite image based on photographing conditions of the plurality of still images or information extracted from the composite image; and
a step of adding noise of the noise amount to the composite image.
